(19) United States
(12) Patent Application Publication
(10) Pub. No.: US 2006/0081617 A1
(43) Pub. Date: Apr. 20, 2006

(54) Method for induction thermal treatment of a domestic water supply pipe and system therefor

(75) Inventors: Laurent Lathus, Avanton (FR); Claude Prioton, Migne Auxances (FR); Fabrice Delpierre, Blandy les Tours (FR); Rodolphe Guitton, Grisy Suisnes (FR); Didier Bailli, Crouzille (FR)

Correspondence Address: YOUNG & THOMPSON, 745 SOUTH 23RD STREET, 2ND FLOOR, ARLINGTON, VA, 22202, US

(73) Assignee: NTU VENTURES PRIVATE LIMITED, SINGAPORE (SG)

(21) Appl. No.: 10/519,556

(22) PCT Filed: Jun. 27, 2003
(86) PCT No.: PCT/FR03/02008

§ 371 Date: Aug. 29, 2005

(30) Foreign Application Priority Data
Jun. 28, 2002 (FR) 02/08060

(51) Int. Cl. H05B 6/10

(52) U.S. Cl. 219/628

(57) ABSTRACT

The invention concerns a system for thermal treatment of a domestic water supply pipe containing stagnant water to eliminate contaminating agents, and in particular legionnellae, comprising a pipe (1) having over its entire length at least a continuous conductive layer made of an ohmic conductor material of the electric current, a connecting element (5) made of a conductor material of the electric current connecting two portions (A, B) of said conductive layer so as to form a conductor closed loop (ABA), and a device for generating a variable magnetic flux throughout said closed loop.

The present invention relates to a method of thermally treating pipes containing the stagnant water of a domestic water distribution network in order to impair contaminating agents, and to a system allowing the implementation of this treatment method.

It is known that wet systems are places where contaminating agents develop. In particular, the legionellae form a particular class of bacteria harmful to human health. One of the main sources of infection consists of the circuits for distributing domestic hot water. The infections are more frequent and more serious if the user's defenses are diminished. That is why the hospital sector is particularly exposed and sensitive to this problem. Since the end of the 1970s and the identification of legionella, incessant efforts have been made to set up procedures and devices for the purpose of decontaminating domestic water installations and for preventing the development of this bacterium.

The proliferation of legionellae is promoted by a water at a temperature lying between 20° C. and 45° C. The proliferation is promoted by a stagnant water. It is also promoted by the presence of other microorganisms, such as protozoa, algae, amoebae, other bacteria, etc which together form an agglomerate called a biofilm which is deposited as a film, whose texture is fatty, on the walls of the pipes in particular. The proliferation of legionellae is promoted by the presence of certain mineral salts. It is these organic and mineral factors promoting the proliferation of the legionellae that are called contaminating agents throughout this application.

The authorities responsible for public health recommend both preventive actions and actions of decontamination of the domestic water distribution installations.

Amongst the preventive recommendations, the planning of the installations is advised in order to limit the portions of the installation favorable to the development of contaminating agents. This involves favoring small dimension networks in which pipes favorable to the stagnation of the water are reduced to a minimum. Once the installation has been completed, the best method of preventing the proliferation is to ensure, for the hot water distribution circuit, a temperature of at least 60° C. in the tank and 50° C. at the taps. In addition, the cold water should remain below 20° C. This is why good insulation between the hot water circuit and the cold water circuit is recommended. All this does not mean that attention should not also be paid to the correct operation and the hygiene of the installation, in particular after a period of shutdown of the installation, by fully flushing the installation and running the water through the taps, and by cleaning with bleach.

Among the decontamination methods, in addition to the less efficient methods such as the use of ultraviolet light, ozonization or ionization, the methods usually used are those of thermal shock and chlorine shock.

The recommended procedure in France for disinfecting the domestic water network by thermal shock consists in increasing the temperature until hot water at 70° C. is obtained at the output of all the taps, and then allowing the water to run for 30 minutes.

The chlorine shock method recommended in France for disinfecting the domestic water network consists in adding chlorine in the form of bleach up to a concentration of 15 mg/l to be maintained for 24 hours and then to empty and flush the installation to clear out the residual chlorine.

Sometimes these two methods are combined by carrying out a chlorine shock followed by a thermal shock.

Although the length of the pipes containing the stagnant water is reduced by optimizing the architecture of the network, these pipes will always exist in a domestic water distribution installation. The thermal separation of the hot water and cold water networks is also not easy to achieve because the pipes of the two networks follow the same service shafts.

The main disadvantage of the thermal or chemical methods of prevention or of decontamination is that it involves treating the whole network.

The ideal thermal values (<20° C. and >45° C.) that have to be permanently maintained throughout the whole network represent a substantial constraint and a major consumption of energy.

In addition, the methods of decontamination require taking the installation out of service throughout the duration of the procedure.

Decontamination by thermal shock is the method of choice in drinking water networks, but feasibility remains doubtful since all the taps of the installation have to be opened and it must be ensured that the water is at 70° C. This technique has the major disadvantage of using a great deal of water and energy. It also causes wear of certain non-heat-resistant materials.

Decontamination by chlorine shock causes corrosion of the ducts (major risk of oxidation on all the metal tubes) and the release of products said to be carcinogenic. The exact dosage of chlorine also presents a risk. And if this chlorine shock is followed by a thermal shock, care has to be taken to properly separate these two operations because the high temperatures promote the formation of toxic substances.

Finally, decontamination is not enough. Periodic preventive procedures have to be put in place to avoid the recolonization of the installation. Thus, for example, the required concentration of chlorine to prevent recolonization is 2 mg/l, which is hard to reconcile with a standard for drinking water of 0.1 mg/l.

Finally, for economic reasons and because hospitals are often the target of major epidemics, other buildings are rarely mentioned in the official documents. The domestic water distribution pipes of a hotel, of a retirement home or of a private dwelling may be contaminated by legionellae and most particularly just upstream of any point of use.

The aim of the invention is to eliminate the aforementioned disadvantages and to propose a method of local thermal treatment, that is to say that makes it possible to treat only the portions of the installation in which the bacterium is likely to develop, that is the pipes containing stagnant water.

Another aim of the invention is to propose a method of thermal treatment whose cost in water and energy is reduced.

A further aim is that the thermal treatment method should be effective, safe and simple to apply.

A further aim of the invention is to propose a reliable device for carrying out this thermal treatment method.

An aim of the invention is also to propose a device that is integrated into the installation when it is planned or is added to the latter subsequently and that where necessary allows remote, centralized technical management by recording, control, etc of the physical variables such as the temperature for example.

A further aim of the invention is to propose a device that allows the method to be usable as a means of decontamination, but also as a means of prevention which can be applied periodically.

The proposed treatment device also aims to reduce the costs of installation and of use relative to the other treatment methods. This is in order that, where appropriate, this device should be used not only in hospitals but also in hotels, retirement homes, private dwellings, etc.

Consequently, the subject of the invention is a method for thermal treatment of a domestic water supply pipe containing stagnant water in order to eliminate contaminating agents, which may be mineral salts such as limestone, a biofilm comprising microorganisms, such as amoebae or bacteria, legionellae in particular, characterized in that said pipe comprises over its entire length at least one continuous conducting layer made of ohmic material conducting electric current, and that the method consists in:
a) connecting two portions of said conducting layer via a linking element made of material conducting electric current in order to form a closed conducting loop
b) generating a variable magnetic flux through said closed loop, in order to induce an electric energy in said closed loop, some or all of said electric energy being dissipated by Joule heating in said conducting layer between said two portions, such that some or all of said heat is transmitted and heats said stagnant water initially to a temperature known as the setpoint
c) maintaining the variable magnetic flux so long as the temperature of the stagnant water has not reached a predetermined threshold value known as the treatment temperature
d) adapting the variable magnetic flux in order to maintain the temperature of the stagnant water at a value equal to or greater than said treatment temperature for a predetermined period, known as the treatment period, sufficient to impair the contaminating agents
e) interrupting the variable magnetic flux after said treatment period.

Advantageously, this method may comprise, before step a), a step of isolating the pipe containing the stagnant water from the rest of the domestic water distribution circuit, by closing a valve downstream and/or a valve upstream of the pipe to be treated, preferably automatically, in order to limit or prevent during the treatment the distribution of the water contained in said pipe, and, after step e), a step of re-establishing the distribution of domestic water through said pipe by reopening said valve or valves, once the temperature of the stagnant water is returned to the setpoint temperature.

Likewise, the method may also comprise, after step e), a step of purging the pipe containing the stagnant water consisting in causing domestic supply water to flow in said pipe, in order to clear away the impaired contaminating agents by discharge.

A further subject of the invention is a system of implementing the preceding method. This system comprises a domestic water supply pipe comprising over its entire length at least one continuous conducting layer made of ohmic material conducting electric current, a linking element made of material conducting electric current connecting two portions of said conducting layer in order to form a closed conducting loop, and a device to generate a variable magnetic flux through said closed loop.

Said conducting pipe comprises preferably at least one tube with a metal core inserted between an inner layer and an outer layer of an electric insulator, the two portions connected by said linking element corresponding to portions of the tube that have been stripped of an outer layer of insulation to expose the metal core and allow an electric contact between the metal core and the linking element.

Said conducting pipe advantageously comprises several tubes with metal core connected by connectors, the electric continuity of the whole pipe being provided at said connectors by intermediate electric linking elements connecting each of the stripped ends, adjacent to a connector, of the tubes situated either side of said connector.

In another embodiment, said conducting pipe comprises several tubes with metal core connected by conducting connectors comprising a layer made of a material conducting electric current.

Preferably, at least one conducting connector comprises at least one shoulder allowing an electric contact between on the one hand the conducting layer of the conducting connector and on the other hand a portion of the metal core, situated at the end of the tube adjacent to the connector, stripped of at least one of its insulating layers.

In another embodiment, at least one conducting connector comprises an outer conducting annular element furnished with spikes projecting radially inward which pass through the outer layer of insulation of the tube and make contact with the metal core of the tube, providing electric continuity between said metal core of said tube and said conducting layer of said conducting connector.

Advantageously, the pipe comprises several tubes having a second metal core forming the linking element placed between said outer layer and the first metal core and separated from the latter by an additional layer of an electric current insulator.

Said device for generating a variable magnetic flux through said loop is preferably a transformer with magnetic core whose primary winding is supplied with a variable current and whose secondary winding consists of said closed conducting loop.

Advantageously, at least one of the conducting connectors, called the transformer connector, comprises on the one hand an inner wall where said current conducting layer is situated, and on the other hand an outer wall defining with the inner wall an annular space between the two walls, in which is housed the magnetic core and the primary winding of said transformer.

In another embodiment, said transformer connector comprises in its outer wall a second layer conducting electric current in electrical connection with said second metal core of the tube and such that the two conducting layers of the transformer connector are electrically insulated one from the other.

The invention will be better understood and other aims, details, features and advantages of the latter will appear more clearly during the following description of several particular embodiments of the invention, given only as a nonlimiting illustration, with reference to the appended drawings.

In these drawings:

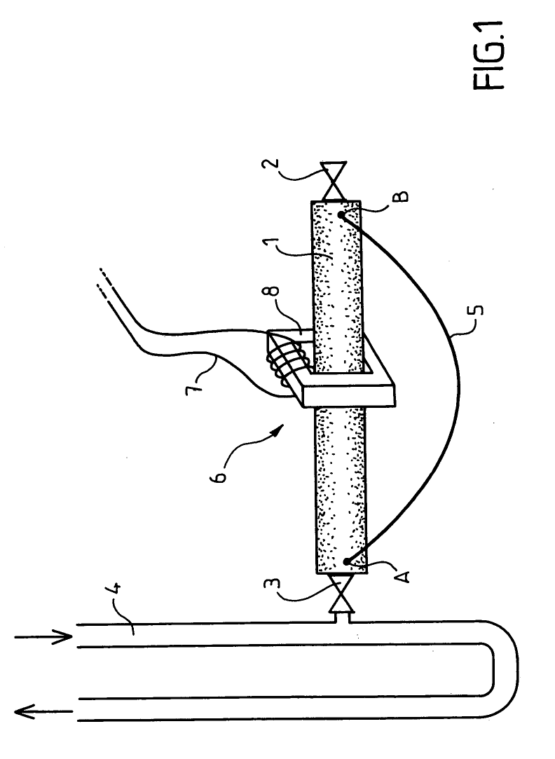

FIG. 1 is a schematic representation of the system according to the invention.

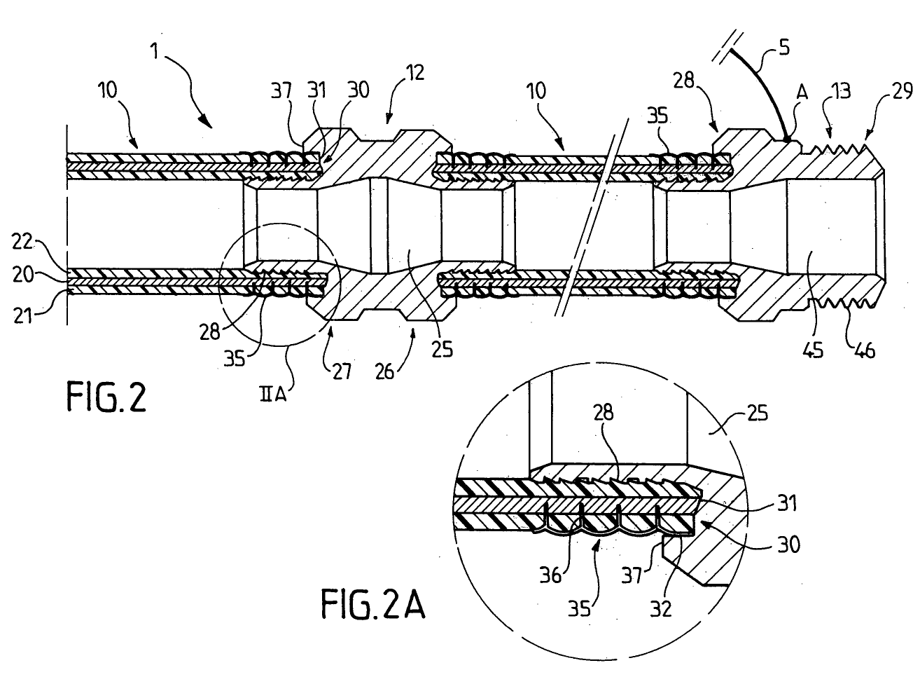

FIG. 2 is a partial axial section of two pipes with metal core, of a conducting connector, and of a conducting end connector, forming part of the system according to a first variant of the invention.

FIG. 2A is an enlarged view of a detail of FIG. 2, as indicated by the circle IIA, representing the link made by means of a barbed collar between the pipe with metal core and the conducting connector.

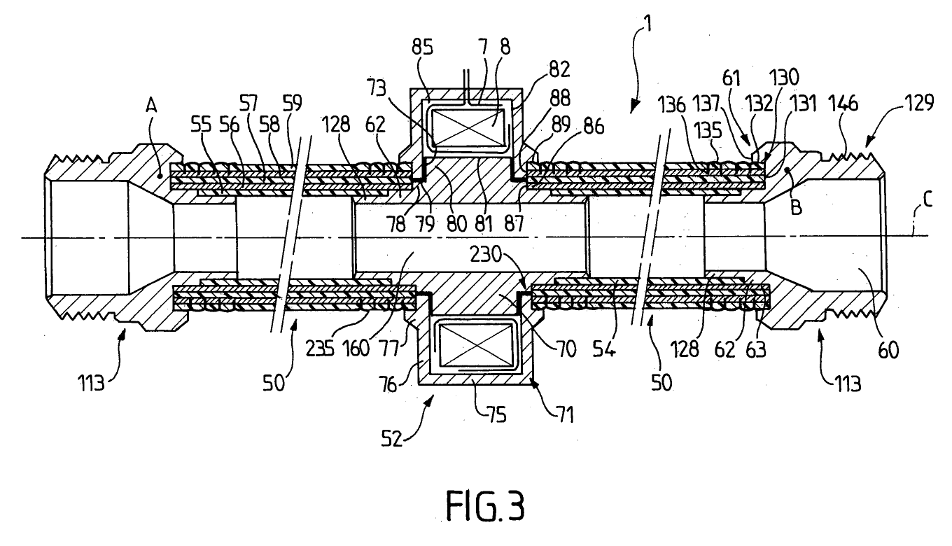

FIG. 3 is a partial axial section of two tubes with double metal core, of two conducting end connectors and of a transformer connector, according to a second variant of the invention.

The elements of the second variant that are identical or analogous to those of the first variant bear the same reference numbers increased by one hundred.

FIG. 1 represents schematically the system of induction thermal treatment according to the invention. A pipe 1, containing stagnant water, is situated between a downstream valve 2, a tap for example, and an upstream valve 3. The water of the pipe 1 is allowed through the upstream valve 3 originating from a domestic water distribution pipe 4. In the particular case of a domestic hot water distribution circuit, a water originating from a generator (not shown), such as a hot water tank, and maintained at a temperature of approximately 60° C., called the setpoint temperature, permanently circulates in the pipe 4.

The pipe 1 must be thermally treated between two points A and B situated at each of the two ends of the pipe 1 in order to impair the contaminating agents which have been able to develop between these points on the inner surface of the pipe 1.

The pipe 1 comprises over its entire length a continuous conducting layer, metal for example or more usually a continuous layer made of an ohmic material conducting electric current.

An electric wire 5, acting as a linking element made out of material conducting electric current, is in electric contact with the conducting layer of the pipe 1 at each of the points A and B. At A or at B, the connection between the electric wire 5 and the conducting layer of the pipe 1 is made, when necessary, by locally stripping the pipe 1, of a layer of insulation for example, at the points A and B in order to reveal the conducting layer. The points A and B are thus placed at the same electric potential. From A to B along the conducting layer of the pipe 1 and from B to A along the electric wire 5, a closed conducting loop, called ABA, has thus been formed.

In FIG. 1, a magnetic core 8 of hollow rectangular section surrounds the pipe 1 at a point situated between the points A and B, the electric wire 5 passing on the outside of the magnetic core 8. In equivalent manner, the magnetic core 8 could be situated at any other point in the closed conducting loop ABA, provided that one of its branches is situated on the outside of the closed loop ABA and that another of its branches is situated on the inside of the closed loop ABA. A primary winding 7, making several turns, for example 222 turns, is wound about the magnetic core 8. This primary winding 7 is powered by a current generator (not shown in FIG. 1) which delivers a variable current, for example a sinusoidal current with a frequency of 50 Hz or 60 Hz and with an amplitude of 3000 A.

Finally, the primary winding 7, the magnetic core 8 and the closed conducting loop ABA form a current transformer 6. The secondary winding of the transformer 6 is nothing other than the closed conducting loop ABA, making a single turn around the magnetic core 8. In another embodiment, the closed conducting loop ABA could make several turns around the magnetic core 8.

When a variable current passes through the primary winding 7, a variable magnetic field is produced along the axis of the N1 turns. This variable magnetic field is concentrated and guided inside the magnetic core 8.

According to the laws of induction, when a variable magnetic field passes through a surface pressing on a conducting loop, a current is induced in that loop. This is the principle that is brought into play when the variable magnetic field is guided in such a manner as to pass through the closed conducting loop ABA forming one turn around the magnetic core 8. The flow of the variable magnetic field through a surface pressing on the closed conducting loop ABA induces an electric current in the closed conducting loop ABA.

Supplementarily, the conducting continuous layer of the pipe 1 being a conductor possessing a cavity, the induced electric current takes the form of an induced current on the outer surface of the conducting continuous layer by Joule heating, called an eddy current.

A portion of the induced electric energy, transported by the induced current, is dissipated by Joule heating in the ohmic conducting layer of the pipe 1. A portion of the heat thus produced heats the conducting continuous layer, is transmitted to the whole wall of the pipe 1 and finally is used to heat the stagnant water contained in the pipe 1.

The temperature of the water rises from an initial temperature to a temperature known as the treatment temperature.

Firstly, the variable current is such that it allows a heating of the system consisting of the pipe 1 between the points A and B and of the stagnant water contained.

Secondly, when the treatment temperature is reached, the variable current powering the primary winding 7 is adapted so as to keep the stagnant water at this treatment temperature for a period called the treatment period. This treatment period and this treatment temperature are defined as a function of the pipe to be treated, of the materials comprising it and of its diameter amongst other things, in order to maximally impair the contaminating agents and to carry out an efficient treatment.

As an example, tests have shown that a period of one hour and a temperature of 90° C. destroy 100% of legionellae.

Finally, after this phase, the variable current powering the primary winding 7 of the transformer 8 is switched off. The temperature of the system comprising the pipe 1 between the points A and B and of the stagnant water contained redescends to a temperature close to the initial temperature. This can be done by simple diffusion of the heat toward the surroundings outside the pipe.

For reasons of safety, during this thermal treatment, the pipe 1 is isolated from the rest of the domestic water distribution circuit. In particular, the downstream valve 2 is moved to the closed position, and locked in order to prevent the distribution of a water whose temperature is not known, and may be very high.

In order to allow the system consisting of the pipe 1 and the stagnant water contained to redescend more quickly to a temperature close to the initial temperature, and to limit the time of unavailability of domestic water distribution, and in order to eliminate from the pipe the impaired contaminating agents in suspension in the stagnant water of the pipe 1, a purging phase will be advantageously carried out by causing water to run through the pipe 1. For this purpose, the two valves 2 and 3 are moved to the open position during the purging phase.

FIG. 2 represents a partial axial section of a particular embodiment of the system according to a first variant of the invention.

The pipe 1 may comprise several tubes 10 interconnected by intermediate conducting connectors 12 and connected to valves for example at the ends of the pipe 1 by end conducting connectors 13.

Each tube 10 consists of a central metal core 20, made of aluminum for example and more generally made of an ohmic material conducting electric current, situated between an inner layer 22 and an outer layer 21 made of an electric current insulating material, of polyethylene for example. The central metal core 20 forms a portion of the conducting continuous layer of the pipe 1 and is used to dissipate the induced electric current by Joule heating. The heat produced in the metal core 20 is transmitted through the inner insulating layer 22 to the water contained in the pipe 1.

The intermediate conducting connector 12, made of metal for example, comprises a main axis of symmetry of revolution. It has a central hole 25 of the same axis, whose diameter may vary along this main axis, for the communication of the water between the two tubes 10 situated either side of the intermediate conducting connector 12. The intermediate conducting connector 12 comprises two identical portions 26 and 27, symmetrical with one another relative to a plane perpendicular to the main axis. Each of the portions 26 and 27 comprises a generally cylindrical skirt 28 whose external diameter is slightly greater than the internal diameter of the tube 10, and furnished on its outer surface with V-shaped notches, in order to produce a hermetic engagement by the notches hooking with the inner layer of insulation 22 of the tube 10, when the skirt 28 of the intermediate conducting connector 12 is fitted to the inside of the end of the tube 10 to be connected. In the connected position, the end portion of the tube 10 butts up against the bottom 31 of an annular recess 30 made opposite it on a radial face 37 of the portion 27 of the intermediate conducting connector 12. The section of this annular recess 30 is generally rectangular and its width is identical to or slightly less than the thickness of the tube 10.

Now with reference to FIG. 2A, this shows in greater detail the junction between the tube 10 with the metal core 20 and the portion 27 of the intermediate conducting connector 12. The electric continuity, along the pipe 1, between the metal core 20 and the intermediate conducting connector 12 is provided by a crimping collar 35. The latter, made of a conducting material, is, at one end, fitted in electric contact with the intermediate conducting connector 12 by contact with the outer edge 32 of the annular recess 30. The crimping collar 35 comprises, at the other end, portions projecting radially inward which, in this particular embodiment, take the form of barbs 36. At the time of crimping of the crimping collar 35, the barbs 36 pierce the insulating outer layer 21 of the tube 10, and make electric contact with the metal core 20 of the tube 10.

Likewise, in FIG. 2, the conducting end connector 13, made of metal for example, comprises a main axis of symmetry of revolution. It has a central hole 45 of the same axis, whose diameter may vary along this main axis, for the communication of the water between the tube 10 and an element of the domestic water distribution installation, a valve for example. The conducting end connector 13 comprises two portions 28 and 29. The portion 28 and the portion 27 of the intermediate conducting connector 12 are identical both in their structure and in their method of connection to the tube 10 to provide hydraulic continuity and electric continuity. The portion 29 may comprise a threaded outer surface 46 for connecting it to a valve for example.

At the ends A or B of the pipe 1, when the end connector is metal, the latter may be connected directly to the electric wire 5, which makes it possible to avoid locally stripping, from the outer layer of insulation 21, the end of the tube 10 close to the end A or B of the pipe 1.

When the intermediate connectors are made of ohmic material conducting electric current, it is also possible to thermally treat the connectors and in particular to impair the biofilm which is deposited at the interface on the inner wall of the hole 25 of the intermediate conducting connector 12.

If these intermediate connectors are not metal, it is then necessary to connect the adjacent tubes 10 either side of the intermediate connector, for example with an outer metal wire acting as an intermediate outer link, to provide electric continuity along the pipe 1. But in this case, the connector is not directly treated. The volume of water that it contains can be treated indirectly by diffusion of the heat from the volumes of water, contained in the tubes 10 adjacent to the intermediate connector, raised to the treatment temperature.

FIG. 3 is a partial axial section of a pipe 1 comprising two tubes 50 with double metal core, of two end conducting connectors 113, and of a central transformer connector 52, according to a second variant of the invention.

The tube 50 comprises, moving radially from the main axis toward the outside, an inner layer of insulation 55, a first metal core 56, an intermediate layer of insulation 57, a second metal core 58 and an outer layer of insulation 59.

The first metal core 56, made of aluminum for example, acts as the continuous conducting layer of the pipe 1 which, by Joule heating, will dissipate the induced current as heat used to heat the domestic water contained in the tube 50.

The second metal core 58, made of aluminum for example, acts as the linking element between the ends of the pipe 1 between which the treatment is applied.

The various insulating layers 55, 57 and 59, made of polyethylene for example, electrically insulate the metal cores from one another and from the external and internal environment.

The end conducting connector 113, made of metal for example, in FIG. 3, is similar to the end connectors previously described in FIG. 2. It comprises a main axis of symmetry of revolution. It has a central hole 60 of the same axis, whose diameter may vary along this main axis, for the communication of the water between the tube 50 and an element of the domestic water distribution installation, a valve for example. The end conducting connector 113 comprises two portions 61 and 129. The portion 129 may comprise a threaded outer surface 146 for connecting it to a valve for example.

The portion 61 comprises a generally cylindrical skirt 128 whose external diameter is slightly greater than the internal diameter of the tube 50, and furnished on its outer surface with V-shaped notches, in order to achieve a hermetic engagement by hooking of the notches with the inner layer of insulation 55 of the tube 50, when the skirt 128 of the portion 61 of the end conducting connector 113 is fitted to the inside of the end of the tube 50 to be connected.

At the base of the skirt 128, the portion 61 of the end conducting connector 113 comprises a shoulder 62, whose thickness is slightly greater than the thickness of the inner layer of insulation 55. An annular portion situated at the end of the inner surface 54 of the tube 50 is stripped of the inner layer of insulation 55. Thus, in connected position, the first metal core 56, on a portion equal to the stripped annular portion, makes electrical contact with the end conducting connector 113 by pressing on the outer cylindrical surface 63 of the shoulder 62.

In connected position, an end portion of the tube 50 butts up against the bottom 131 of an annular recess made opposite it on a radial face 137 of the portion 61 of the end conducting connector 113. The section of this annular recess 130 is generally rectangular and its width is identical to the total thickness of the four outer layers 56, 57, 58 and 59 of the tube 50.

Electrical continuity, between the second metal core 58 and the end conducting connector 113 is provided by means of a crimping collar 135. The latter, made of conducting material, is, at one end, fitted in electric contact with the end conducting connector 113 by contact with the outer edge 132 of the annular recess 130. The crimping collar 135 comprises, at the other end, portions projecting radially inward which, in this particular embodiment, take the form of barbs 136. At the time of crimping of the crimping collar 135, the barbs 136 pierce the outer insulating layer 59 of the tube 50 and make electric contact with the second metal core 58 of the tube 50, without touching the layer 56.

Through the portion 61 of the end conducting connector 113, the two metal cores 56 and 58 of the tube 50 are placed in electric continuity. At the ends A and B of the pipe 1, the points of electric contact, between the continuous conducting layer of the pipe 1 which, in this variant of the invention, consists of the first metal core 56 and the linking element which, in this variant of the invention, consists of the second metal core 59, have been thus created.

The transformer connector 52 comprises two pieces 70 and 71, with symmetry of revolution along the same axis, made of conducting material. The piece 71 surrounds the piece 70 and is separated from the latter by a coating of electric insulation 73.

The piece 71 is annular and exhibits a C-section open toward its axis, with an axially external wall 75. The lateral walls 76 of the piece 71 comprise portions 77 projecting axially outward situated at a certain distance from the inner edge of the lateral wall 76. As an example, the piece 71 consists of two half-shells so that they can be mounted on the piece 70.

The piece 70, symmetrical relative to a mid-plane orthogonal to the main axis, has a central hole 160 of the same axis as the piece 70, whose diameter may vary along this main axis, for the communication of the water between the tubes 50 placed either side of the transformer connector 52.

The piece 70 comprises a skirt 128 and a first shoulder 62 broadly described hereinabove in the particular case of the end conducting connector 113.

At the base of this first shoulder 62, the piece 70 comprises a second shoulder 78 whose thickness is less than the total thickness of the intermediate layer of insulation 57 and of the first metal core 56. The inner surface of the inner edge of the lateral wall 76 of the piece 71 presses the coating of electric insulation 73 against the outer cylindrical surface 79 of this second shoulder 78.

At the base of this second shoulder 78, the piece 70 comprises a third shoulder 80 forming a central body of the piece 70. The thickness of this third shoulder 80 is less than the depth of the interior cavity of the piece 71, such that, when the pieces 70 and 71 are positioned one with the other, the axially outer surface 81 of this third shoulder 80 and the inner surface 82 of the piece 71 form an annular space 85.

The outer axial surface 86 of the first shoulder 62 of the piece 70, the outer radial surface 87 of the second shoulder 78 of the piece 70, the outer radial surface 88 of the inner edge of the lateral wall 76 of the piece 71 and the inner axial surface 89 of the projection 77 of the lateral wall 76 of the piece 71 form, when the pieces 70 and 71 are positioned one with the other, the walls of an annular recess 230.

In connected position, the end portion of the tube 50 butts up against the bottom of the annular recess 230. The distance between the axial walls of this annular recess 230 is identical to or less than the total thickness of the four outer layers 56, 57, 58 and 59 of the tube 50.

The electric continuity between the second metal core 58 and the piece 71 of the transformer connector 52 is provided by means of a crimping collar 235. The latter, made of conducting material, is at one end fitted in electric contact with the piece 71 by contact with the outer edge of the annular recess 230 which is in fact the inner axial surface 89 of the projection 77 of the lateral wall 76 of the piece 71. At the other end, the crimping collar 235 comprises barbs which provide the contact with the second metal core 58 of the tube 50 as has already been mentioned.

Thus the continuity of the inner layer of the pipe 1 is achieved by connecting the first metal cores 56 of the tubes 50 situated either side of the transformer connector 52 by means of the inner conducting piece 70 of the transformer connector 52. The continuity of the linking element is achieved by connecting the second metal cores 58 of the tubes 50 situated either side of the transformer connector 52 by means of the outer conducting piece 71 of the transformer connector 52.

The toroidal magnetic core 8 of the transformer is housed in the annular space 85. The magnetic core 8 is surrounded on its entire perimeter by the primary winding 7 of the transformer. The primary winding 7, insulated from the conducting pieces 70 and 71, is powered by a variable current from a generator (not shown).

The variable current induces a magnetic field which is directed in a direction perpendicular to the axis C of the tubes. This magnetic field, guided by the toroidal magnetic core 8, generates an induced current in the inner conducting piece 70 of the transformer connector 52, the first metal cores 56 of the tubes 50 and the end connectors 51. These elements constituting the continuous conducting layer of the pipe 1 being placed at the same potential at the points A and B by the second metal cores 58 of the tubes 50 and the outer conducting piece 71 of the transformer connector 52, the induced current is dissipated by Joule heating. The heat produced is used to take the domestic water contained in the tubes 50 and the transformer connector 52 to the treatment temperature.

This temperature maintained during a treatment period is used to impair the legionellae and to break up some or all of the biofilm, which is a film of fatty texture deposited on the inner surfaces of the tubes 50 and of the connectors 51, 52.

In the embodiments of the invention presented in detail above, mention has been made of rectilinear pipe only. This aspect of the invention is worthy of being stated.

The principle of the induction on which the present invention is based requires only the presence of a conducting circuit whose two ends are at the same potential, so that an electric current is induced in this circuit. Hereinafter, the general laws of electricity are applied to the current induced in this circuit; if there is an ohmic conducting element, Joule's law is applied; if the circuit is divided into two parallel branches, the current circulating in each branch may be known as a function of the parameters of each of the branches, the current division law being applied; etc.

The simplest closed circuit is evidently the closed conducting loop mentioned hereinabove. But the invention applies for example to a pipe having a first tube with metal core connected to two other tubes by means of a T-shaped intermediate conducting connector, provided that the ends of the three tubes are connected by a linking element placing them at the same potential. But since the currents circulating in the various tubes are not the same, if the latter have the same physical features, the temperature of the volume the stagnant water in each of them will be different.

Scientific studies covering the induction thermal treatment according to the invention have been conducted.

These studies first made it possible to better understand the mechanism leading to the effectiveness of the invention. It proves that induction thermal treatment first allows the inner surface of the tube to reach a high temperature of the order of 100° C. This sharp rise in the temperature, accompanied by a dilation of the surface and by secondary magnetic effects dependent on the frequency of the induced current, makes it possible to detach the scale and the biofilm within which the bacteria are protected. Then, secondly, by thermal convection, all the liquid contained in the pipe to be treated is taken to a high temperature causing the fauna contained in the liquid to be destroyed.

These studies were then used to reveal that, for a curative treatment, taking the content of the pipe to a temperature of 85 to 90° C. for a period of 30 minutes, as recommended by the French Ministerial circular DGS/SD7A/SD5C-DHOS/E4 No. 2002/243 concerning the prevention of risk relating to legionellae in health establishments, is insufficient. Preferably, a treatment at a temperature of 80° C. for 60 minutes seems more suitable for destroying the legionellae. Again preferably, a treatment at a temperature of 90° C. for 60 minutes can be used to destroy all the bacteria and mesophile amoebae.

Furthermore, in the case of a preventive treatment, the protocol aimed at preventing contamination of the tubes and consisting in treating the pipework of a network at a temperature of 90° C. for 10 minutes once a week has been validated by these studies.

It has been revealed that induction thermal treatment does not damage the structure of the tube. For example, for a copper tube, no metal ion was detected in the liquid contained in the treated pipe. As a consequence, the composition of the distributed water is not modified by the induction thermal treatment.

Consequently, and for the particular case of the hospital sector in which the standards are the most draconian, the Applicant proposes a series of numerical values. The electric energy used in the primary is advantageously that of the mains with a 50 or 60 Hz frequency and a 220 V voltage. The current in the secondary circuit consisting of the continuous conducting loop is 3000 A, but at a very low voltage varying between 1 and 10 V. This low potential difference ensures perfect security for the users.

To limit the emissions of electromagnetic radiation by the loop itself, with the aim of conforming to the standards NF EN 60601-1-1 and 1-1-2 relating to medical appliances and C18-600 relating to low-frequency electromagnetic fields, special inductors having a high efficiency of the order of 98% are preferably used. In addition, the electric linking elements necessary for forming the continuous conducting loop must follow as readily as possible the path defined by the tube to be treated. The tube comprising a double metal core is then particularly suitable.

To give an idea, the treatment of a tube having a diameter of 16 mm, a thickness of 4 mm and a length of 16 m consumes less than 0.55 kWh of electricity during a curative treatment.

The Applicant has carried out simulations of the installation of a thermal treatment device on an entire domestic hot water distribution network, either for the case of a pre-existing network, or for the case of a network fitted at conception. These simulations lead to the belief that the installation costs are low and amortized over the first years of operation of the network, due to the low maintenance costs of the treatment device according to the invention, its low energy consumption and its zero consumption of water and chemical product.

Finally, the induction thermal treatment of a domestic hot water distribution network may be entirely controlled and automated. The traceability of the induction thermal treatment is fully in line with the abovementioned circular.

It should be noted that the induction thermal treatment, although it has been described in detail for the case of the pipes of domestic hot water distribution installations in the hospital environment, may also be used in all sensitive buildings (retirement home, laboratories, etc), in public places of water distribution (swimming pools, public fountains, etc) or yet in ventilation and/or air conditioning devices in which the water risks stagnating and/or being sprayed into the atmosphere in aerosol form.

Incidentally, an inverter placed in the electric circuit and suitable for modifying the frequency of the induced current makes it possible to use the induction thermal treatment device as a means for counteracting furring in the pipes.

Although the invention has been described in relation to several particular embodiments, it is evident that it is in no way limited to them and that it comprises all the technical equivalents of the means described and their combinations if the latter enter into the scope of the invention.

1. A method for thermal treatment of a domestic water supply pipe containing stagnant water in order to eliminate contaminating agents, which may be mineral salts such as limestone, a biofilm comprising microorganisms, such as amoebae or bacteria, legionellae in particular, characterized in that said pipe (1) comprises over its entire length at least one continuous conducting layer (20; 56) made of ohmic material conducting electric current, and that the method consists in:
a) connecting two portions of said conducting layer via a linking element made of material conducting electric current in order to form a closed conducting loop
b) generating a variable magnetic flux through said closed loop, in order to induce an electric energy in said closed loop, some or all of said electric energy being dissipated by Joule heating in said conducting layer between said two portions, such that some or all of said heat is transmitted and heats said stagnant water initially to a temperature known as the setpoint
c) maintaining the variable magnetic flux so long as the temperature of the stagnant water has not reached a predetermined threshold value known as the treatment temperature
d) adapting the variable magnetic flux in order to maintain the temperature of the stagnant water at a value equal to or greater than said treatment temperature for a predetermined period, known as the treatment period, sufficient to impair the contaminating agents
e) interrupting the variable magnetic flux after said treatment period.

2. The method as claimed in claim 1, characterized in that it comprises, before step a), a step of isolating the pipe (1) containing the stagnant water from the rest of the domestic water distribution circuit (4), by closing a valve downstream (2) and/or a valve upstream (3) of the pipe to be treated, in order to limit or prevent during the treatment the distribution of the water contained in said pipe, and, after step e), a step of re-establishing the distribution of domestic water through said pipe by reopening said valve or valves (2, 3), once the temperature of the stagnant water is returned to the setpoint temperature.

3. The method as claimed in claim 1, characterized in that it comprises, after step e), a step of purging the pipe (1) containing the stagnant water consisting in causing domestic supply water to flow in said pipe, in order to clear away the impaired contaminating agents by discharge.

4. A system of implementing the method according to claim 1, characterized in that it comprises a domestic water supply pipe (1) comprising over its entire length at least one continuous conducting layer (20; 56) made of ohmic material conducting electric current, a linking element (5; 59, 71) made of material conducting electric current connecting two portions (A, B) of said conducting layer in order to form a closed conducting loop (ABA), and a device to generate a variable magnetic flux through said closed loop.

5. The system as claimed in claim 4, characterized in that said conducting pipe comprises at least one tube (10; 50) with a metal core (20; 56) inserted between an inner layer and an outer layer of an electric insulator (21, 22; 55, 59), the two portions connected by said linking element corresponding to portions of the tube that have been stripped of an insulating layer to expose the metal core and allow an electric contact between the metal core and the linking element.

6. The system as claimed in claim 5, characterized in that said conducting pipe comprises several tubes (10; 50) with metal core connected by connectors, the electric continuity of the whole pipe being provided at said connectors by intermediate electric linking elements connecting each of the stripped ends, adjacent to a connector, of the tubes situated either side of said connector.

7. The system as claimed in claim 5, characterized in that said conducting pipe comprises several tubes (10; 50) with metal core connected by conducting connectors (12, 28; 52, 113) comprising a layer made of a material conducting electric current.

8. The system as claimed in claim 7, characterized in that at least one conducting connector (70; 113) comprises at least one shoulder (62) allowing an electric contact between on the one hand the conducting layer of the conducting connector and on the other hand a portion of the metal core (56), situated at the end of the tube adjacent to the connector, stripped of at least one of its insulating layers (55).

9. The system as claimed in claim 7, characterized in that at least one conducting connector (12, 13) comprises an outer conducting annular element (35) furnished with spikes projecting radially inward (36) which pass through the outer layer of insulation (21) of the tube (10) and make contact with the metal core (20) of the tube, providing electric continuity between said metal core of said tube and said conducting layer of said conducting connector.

10. The system as claimed in claim 5, characterized in that the pipe comprises several tubes (50) having a second metal core (58) forming the linking element placed between said outer layer (59) and the first metal core (56) and separated from the latter by an additional layer (57) of an electric current insulator.

11. The system as claimed in claim 7, characterized in that said device for generating a variable magnetic flux through said loop (ABA) is a transformer (6) with magnetic core (8) whose primary winding (7) is supplied with a variable current and whose secondary winding consists of said closed conducting loop.

12. The system as claimed in claim 11, characterized in that at least one of the conducting connectors (52), called the transformer connector, comprises on the one hand an inner wall (70) where said current conducting layer is situated, and on the other hand an outer wall (71) defining with the inner wall an annular space (85) between the two walls, in which is housed the magnetic core (8) and the primary winding (7) of said transformer (6).

13. The system as claimed in claim 12, characterized in that said transformer connector (52) comprises in its outer wall (71) a second layer conducting the electric current in electrical connection with said second metal core (58) of the tube (50) and such that the two conducting layers of the transformer connector are electrically insulated one from the other.
